(19) United States
(12) Patent Application Publication
(10) Pub. No.: US 2013/0235961 A1
(43) Pub. Date: Sep. 12, 2013

(54) APPARATUS AND METHOD FOR REDUCING RX CALIBRATION DELAY IN WIRELESS COMMUNICATION SYSTEM

(71) Applicant: SAMSUNG ELECTRONICS CO., LTD., Suwon-si (KR)

(72) Inventors: Yeo-Joon YOON, Seoul (KR); Tae-Hui CHO, Gunpo-si (KR); Hyung-Weon PARK, Seoul (KR)

(73) Assignee: SAMSUNG ELECTRONICS CO. LTD., Suwon-si (KR)

(21) Appl. No.: 13/785,317

(22) Filed: Mar. 5, 2013

(30) Foreign Application Priority Data
Mar. 9, 2012 (KR) 10-2012-0024597

(51) Int. Cl. H04B 1/12

(52) U.S. Cl. CPC H04B 1/123
USPC 375/350

(57) ABSTRACT

An apparatus and a method for removing RX DC in a wireless communication system are provided. A receiver apparatus includes a local oscillator, a mixer for converting a received signal to a baseband signal using a frequency provided from the local oscillator, and a DC compensator, comprising an operational amplifier and a low pass filter, for compensating DC in an output signal of a frequency converter by adjusting a pass band size of the low pass filter.

### PRIORITY

This application claims the benefit under 35 U.S.C. §119(a) of a Korean patent application filed on Mar. 9, 2012 in the Korean Intellectual Property Office and assigned Serial No. 10-2012-0024597, the entire disclosure of which is hereby incorporated by reference.

### BACKGROUND OF THE INVENTION

1. Field of the Invention

The present disclosure relates to an apparatus and a method for reducing signal distortion in a wireless communication system. More particularly, the present disclosure relates to an apparatus and a method for reducing signal distortion in a wireless communication system using multiple bands.

2. Description of the Related Art

When a wireless communication system uses multiple bands, a terminal can perform handover from a current serving band to a target band. In so doing, the terminal measures RX parameters of the target band to which the terminal performs the handover.

When measuring the RX parameters of the target band for the handover, the terminal utilizes different RX paths per band and differently sets a Radio Frequency Integrated Circuit (RFIC) per band. As a result, the RX DC can distort a signal. To reduce the signal distortion of the RX DC, the terminal calibrates the RX DC. For example, before measuring the RX parameters of the target band, the terminal calibrates the RX DC of the target band.

To calibrate the RX DC, the terminal needs to sequentially optimize the RX DC of N-ary Variable Gain Amplifiers (VGAs) which form the RFIC.

Disadvantageously, the time delay for the RX DC calibration can shorten the time taken for the terminal to measure the RX parameters of the target band.

Therefore, a need exists for an apparatus and a method for reducing signal distortion of RX DC in a wireless communication system using multiple bands.

The above information is presented as background information only to assist with an understanding of the present disclosure. No determination has been made, and no assertion is made, as to whether any of the above might be applicable as prior art with regard to the present disclosure.

### SUMMARY OF THE INVENTION

Aspects of the present disclosure are to address at least the above-mentioned problems and/or disadvantages and to provide at least the advantages described below. Accordingly, an aspect of the present disclosure is to provide an apparatus and a method for reducing signal distortion of RX DC in a wireless communication system using multiple bands.

Another aspect of the present disclosure is to provide an apparatus and a method for reducing signal distortion of RX DC when measuring RX parameters of a particular band in a wireless communication system using multiple bands.

Yet another aspect of the present disclosure is to provide an apparatus and a method for reducing signal distortion of RX DC when measuring RX parameters of a particular band in a terminal of a wireless communication system using multiple bands.

Still another aspect of the present disclosure is to provide an apparatus and a method for reducing RX DC calibration delay in a wireless communication system.

A further aspect of the present disclosure is to provide an apparatus and a method for reducing RX DC calibration delay in a terminal of a wireless communication system.

A further aspect of the present disclosure is to provide an apparatus and a method for reducing RX DC calibration delay by improving a Digital/Analog Converter (DAC) scan time in a terminal of a wireless communication system.

In accordance with an aspect of the present disclosure, a receiver apparatus in a wireless communication system is provided. The apparatus includes a local oscillator, a mixer for converting a received signal to a baseband signal using a frequency provided from the local oscillator, and a DC compensator, including an operational amplifier and a low pass filter, for compensating DC in an output signal of a frequency converter by adjusting a pass band size of the low pass filter.

In accordance with another aspect of the present disclosure, a method for removing RX DC in a receiver of a wireless communication system is provided. The method includes down-converting a received signal to a baseband signal using a frequency converter and compensating for DC in the baseband signal by adjusting a pass band size of a low pass filter of a DC compensator.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF THE DRAWINGS

The above and other aspects, features, and advantages of certain exemplary embodiments of the present disclosure will be more apparent from the following description taken in conjunction with the accompanying drawings, in which:

FIG. 1 is a block diagram for compensating for RX DC in a wireless communication system according to an exemplary embodiment of the present disclosure;

FIG. 2 is a block diagram of a DC compensator according to an exemplary embodiment of the present disclosure;

FIG. 3 is a flowchart of a method for reducing signal distortion of RX DC in a wireless communication system according to an exemplary embodiment of the present disclosure;

FIG. 4 is a block diagram for compensating for RX DC in a wireless communication system according to an exemplary embodiment of the present disclosure; and

FIG. 5 is a flowchart of a method for reducing a signal distortion of RX DC in a wireless communication system according to an exemplary embodiment of the present disclosure.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present disclosure provide a technique for reducing signal distortion of RX DC during a gap measurement section in a wireless communication system using multiple bands.

Hereinafter, it is assumed that a terminal of a wireless communication system measures RX parameters of a target band in a gap measurement section.

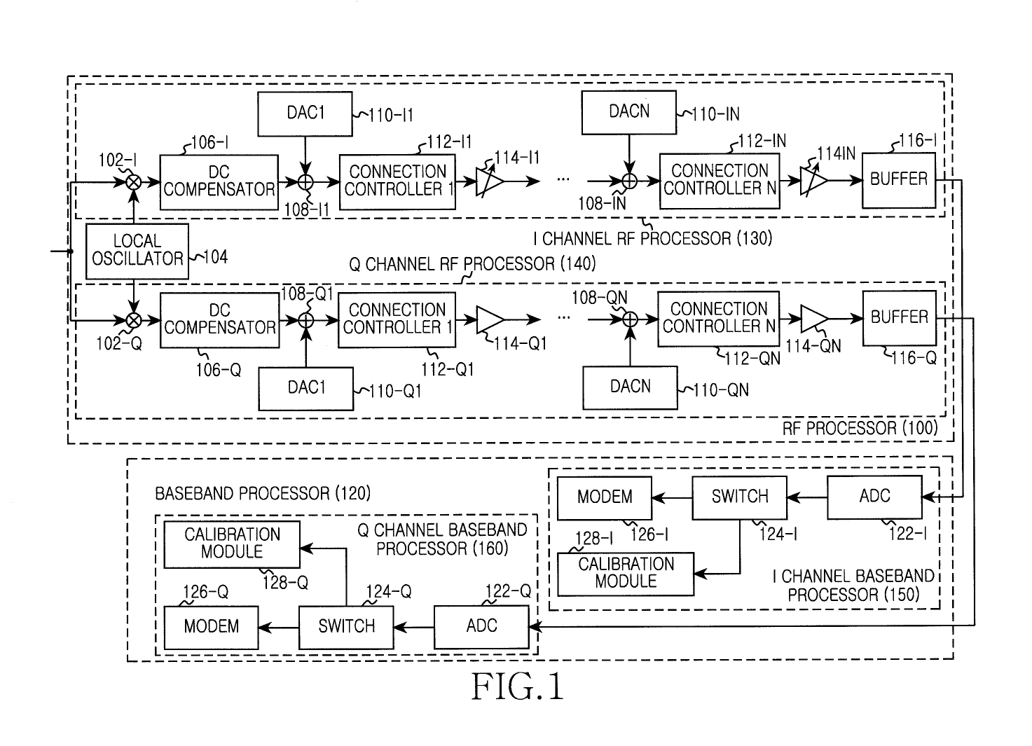

FIG. 1 is a block diagram for compensating for RX DC in a wireless communication system according to an exemplary embodiment of the present disclosure.

Referring to FIG. 1, the terminal includes a Radio Frequency (RF) processor 100 and a baseband processor 120.

The RF processor 100 includes an I channel RF processor 130, a Q channel RF processor 140, and a local oscillator 104. Since the I channel RF processor 130 and the Q channel RF processor 140 have the same structure with different signal channels processed, the I channel RF processor 130 is explained alone.

The local oscillator 104 generates a frequency for converting a received signal to a baseband signal in an I channel and a Q channel according to band information determined by the terminal to send and receive the signal.

The I channel RF processor 130 includes a mixer 102-I, a DC compensator 106-I, adders 10841 through 108-IN, Digital/Analog Converters (DACs) 110-I1 through 110-IN, connection controllers 112-I1 through 112-IN, RX Variable Gain Amplifiers (VGAs) 114-I1 through 114-IN, and a buffer 116-I.

The mixer 102-I converts an input signal to the baseband signal using the frequency provided from the local oscillator 104.

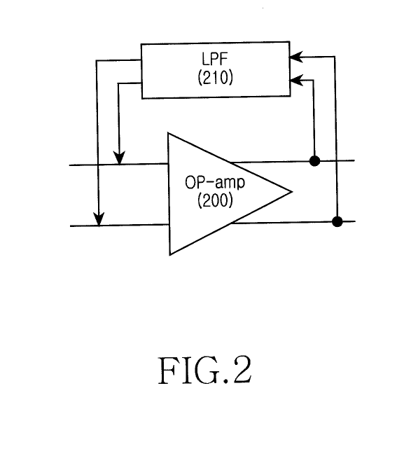

FIG. 2 is a block diagram of a DC compensator according to an exemplary embodiment of the present disclosure.

Referring to FIG. 2, the DC compensator 106-I compensates for a DC offset of the baseband signal provided from the mixer 102-I. For example, the DC compensator 106-I includes an Operational Amplifier (OP AMP) 200 and a Low Pass Filter (LPF) 210.

The LPF 210 can remove a DC signal by short-circuiting input and output stages of the OP AMP 200. In so doing, the DC compensator 106-I compensates for the DC of the OP AMP 200 using a DC compensation time which varies according to a pass band size of the LPF 210. For example, for the wide pass band, the LPF 210 filters the DC widely and shortens the DC compensation time. For the narrow pass band, the LPF 210 filters only the DC and thus, signal quality does not degrade due to minimum signal loss around the DC. Hence, when a start point of RX DC calibration arrives, the LPF 210 shortens the DC compensation time by expanding the pass band. Thereafter, when the RX DC calibration section ends, the LPF 210 reduces the pass band to prevent the signal quality degradation. Herein, the I channel and the Q channel each include a + channel and a − channel (not shown). Accordingly, the DC compensator 106-I of FIG. 2 compensates for the DC of the + channel and the − channel in any one of the I channel and the Q channel.

Referring again to FIG. 1, the adders 10841 through 108-IN add the signals output from the DACs 110-I1 through 110-IN to the input signal so as to minimize the DC of the RX VGAs 114-I1 through 114-IN.

The connection controllers 112-I1 through 112-IN, at their initial setting, sequentially block the DC value input to the RX VGAs 114-I1 through 114-IN so as to set the DAC value of the DACs 110-I1 through 110-IN to minimize the DC of the RX VGAs 114-I1 through 114-IN. For example, when the RX DC calibration is conducted for the initial setting, the I channel RF processor 130 blocks the DC value input to the N-th RX VGA 114-IN using the N-th connection controller 112-IN. In so doing, the N-th DAC 110-IN determines a DAC value for minimizing the DC of the N-th RX VGA 114-IN. Thereafter, the RF processor 130 blocks the DC value input to the (N−1)-th RX VGA 114-I(N−1) using the (N−1)-th connection controller 112-I(N−1). In so doing, the (N−1)-th DAC 110-I(N−1) determines a DAC value for minimizing the DC of the (N−1)-th RX VGA 114-I(N−1). Herein, the N-th connection controller 112-IN connects the (N−1)-th RX VGA 114-I(N−1) and the N-th RX VGA 114-IN.

As such, when the I channel RF processor 130 performs the RX DC calibration for the initial setting, the DC value input to the RX VGAs 114-I1 through 114-IN is sequentially blocked using the respective connection controllers 112-I1 through 112-IN.

The RX VGAs 114-I1 through 114-IN variably amplify the input signal according to the input signal level in order to apply the constant signal level to the baseband processor 120. For example, for the high input signal level, the RX VGAs 114-I1 through 114-IN amplify the signal with a small gain. By contrast, for the low input signal level, the RX VGAs 114-I1 through 114-IN amplify the signal with a great gain.

The buffer 116-I is disposed at an output stage of the I channel RF processor 130 and used to lower output impedance of the I channel RF processor 130.

The baseband processor 120 includes an I channel baseband processor 150 and a Q channel baseband processor 160. Hereafter, the I channel baseband processor 150 is explained alone since the I channel baseband processor 150 and the Q channel baseband processor 160 have the same structure with different signal channels processed.

The I channel baseband processor 150 includes an Analog/Digital Converter (ADC) 122-I, a switch 124-I, a modem 126-I, and a calibration module 128-I.

The ADC 122-I converts an analog signal output from the I channel RF processor 130 to a digital signal.

The switch 124-I controls connections of the ADC 122-I, the modem 126-I, and the calibration module 128-I according to the RX DC calibration. For example, for the RX DC calibration, the switch 124-I connects the ADC 122-I and the calibration module 128-I. For example, when the RX DC calibration is not conducted, the switch 124-I connects the ADC 122 and the modem 126-I.

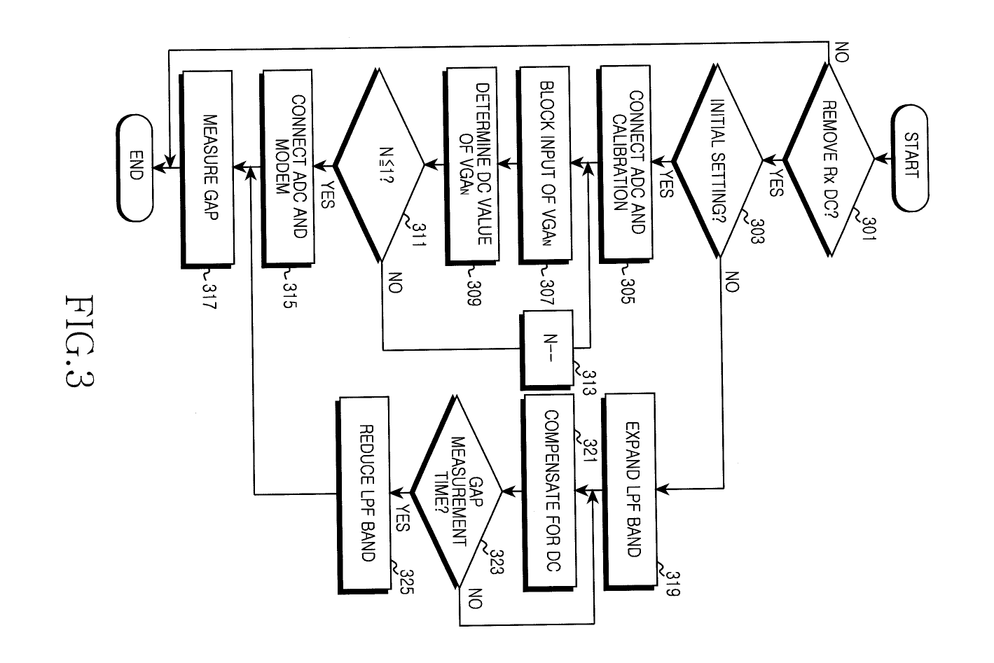

FIG. 3 is a flowchart of a method for reducing signal distortion of RX DC in a wireless communication system according to an exemplary embodiment of the present disclosure.

Referring to FIG. 3, the terminal of the wireless communication system determines whether to remove the RX DC in step 301.

When determining not to remove the RX DC, the terminal finishes this process.

By contrast, when the terminal determines to remove the RX DC, the terminal determines whether the RX DC is removed for the initial setting in step 303.

When the RX DC is removed for the initial setting, the terminal sets to provide the output signal of the RF processor to the calibration module of the baseband processor for the RX DC calibration in step 305. For example, the terminal connects the ADC 122-I and the 122-Q and the calibration module 128-I and the 128-Q using the switch 124-I and the 124-Q of the baseband processor 120 of FIG. 1.

In step 307, the terminal blocks the input of the N-th VGA. For example, the terminal blocks the DC value input to the N-th VGA. Herein, N, which is an initial value, includes the total number of the VGAs of the RF processor.

In step 309, the terminal determines the DAC value to minimize the DC of the N-th VGA by changing the DAC value of the N-th DAC.

In step 311, the terminal compares an index N of the VGA with 1 so as to determine whether the DAC value is determined for every VGA of the RF processor.

When the index N of the VGA is greater than 1, the terminal recognizes that the DAC values of all of the VGAs of the RF processor are not determined. Hence, the terminal updates the VGA index (N—) in step 313.

In step 307, the terminal blocks the input of the VGA having the index updated in step 313.

By contrast, when the VGA index N is 1 in step 311, the terminal recognizes that the DAC values of all of the VGAs of the RF processor are determined. Thus, the terminal sets to provide the output signal of the RF processor to the modem of the baseband processor for the RX parameter measurement in step 315. For example, when the terminal is constructed as shown in FIG. 1, the terminal connects the ADC 122-I and 122-Q and the modem 126-I and 126-Q using the switches 124-I and 124-Q of the baseband processor 120.

In step 317, the terminal measures the RX parameters of the corresponding band.

By contrast, when the RX DC is removed not for the initial setting in step 303, the terminal expands the pass band of the LPF 210 of the DC compensator to reduce the DC compensation time in step 319.

In step 321, the terminal compensates for the DC using the LPF 210 of the expanded pass band.

In step 323, the terminal determines whether a gap measurement point comes.

When the gap measurement point does not come, the terminal compensates for the DC using the LPF 210 of the expanded pass band in step 321.

By contrast, when the gap measurement point comes, the terminal reduces the pass band of the LPF 210 of the DC compensator in order to avoid the signal quality degradation in step 325.

In step 317, the terminal measures the RX parameters of the corresponding band and finishes this process.

In an exemplary embodiment of the present disclosure, the DC compensator expands the pass band of the LPF at a preset start point of the RX DC calibration, and reduces the pass band of the LPF at a preset end point of the RX DC calibration.

Alternatively, the DC compensator may determine the pass band reduction point of the LPF by considering the DC component size of the output signal of the DC compensator.

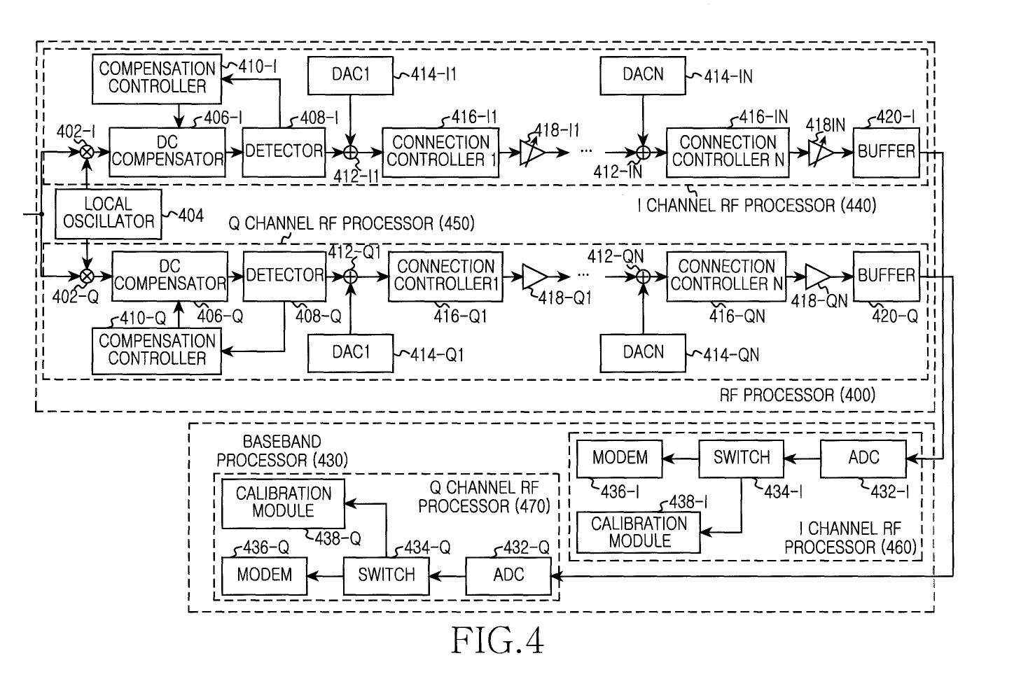

FIG. 4 is a block diagram for compensating for RX DC in a wireless communication system according to an exemplary embodiment of the present disclosure.

Referring to FIG. 4, the terminal includes an RF processor 400 and a baseband processor 430.

The RF processor 400 includes an I channel RF processor 440, a Q channel RF processor 450, and a local oscillator 404. Since the I channel RF processor 440 and the Q channel RF processor 450 have the same structure with different signal channels processed, the I channel RF processor 440 is explained alone.

The local oscillator 404 generates a frequency for converting a received signal to a baseband signal in the I channel and the Q channel according to band information determined by the terminal to send and receive the signal.

The I channel RF processor 440 includes a mixer 402-I, a DC compensator 406-I, a detector 408-I, a compensation controller 410-I, adders 412-I1 through 412-IN, DACs 414-I1 through 414-IN, connection controllers 416-I1 through 416-IN, RX VGAs 418-I1 through 418-IN, and a buffer 420-I.

The mixer 402-I converts an input signal to the baseband signal using the frequency provided from the local oscillator 404.

The DC compensator 406-I compensates for a DC offset of the baseband signal provided from the mixer 402-I under control of the compensation controller 410-I. For example, the DC compensator 406-I includes the OP AMP 200 and the LPF 210 as shown in FIG. 2. For example, the LPF 210 can remove the DC signal by short-circuiting the input and output stages of the OP AMP 200. When the start point of the RX DC calibration arrives, the LPF 210 shortens the DC compensation time by expanding the pass band under the control of the compensation controller 410-I. Thereafter, the LPF 210 reduces the pass band under the control of the compensation controller 410-I to prevent the signal quality degradation. Herein, the I channel and the Q channel each include the + channel and the − channel (not shown). Accordingly, the DC compensator 106-I of FIG. 2 compensates for the DC of the + channel and the − channel in any one of the I channel and the Q channel.

The detector 408-I detects the DC component in the output signal of the DC compensator 406-I.

The compensation controller 410-I controls the pass band size of the LPF 210 of the DC compensator 406-I according to the DC component size detected by the detector 408-I. For example, as the pass band widens, the LPF 210 filters the DC widely and shortens the DC compensation time. As the pass band narrows, the LPF 210 filters only the DC component and thus the signal quality does not degrade due to minimum signal loss around the DC. Hence, when the start point of the RX DC calibration arrives, the compensation controller 410-I controls to expand the pass band of the LPF 210 of the DC compensator 406. In the meantime, when the DC component detected by the detector 408-I falls within a reference DC range, the compensation controller 410-I controls to reduce the pass band of the LPF 410 of the DC compensator 406. Herein, the reference DC range can be determined based on the DC component size in the detected input signal after the RX DC calibration for the initial setting.

The adders 412-I1 through 412-IN add the signals output from the DACs 414-I1 through 414-IN to the input signal so as to minimize the DC of the RX VGAs 418-I1 through 418-IN.

The connection controllers 416-I1 through 416-IN, at their initial setting, sequentially block the DC value input to the RX VGAs 418-I1 through 418-IN so as to set the DAC value of the DACs 414-I1 through 414-IN to minimize the DC of the RX VGAs 418-I1 through 418-IN. For example, when the RX DC calibration is conducted for the initial setting, the I channel RF processor 440 blocks the DC value input to the N-th RX VGA 418-IN using the N-th connection controller 416-IN. In so doing, the N-th DAC 414-IN determines the DAC value for minimizing the DC of the N-th RX VGA 418-IN. Thereafter, the RF processor 440 blocks the DC value input to the (N−1)-th RX VGA 418-I(N−1) using the (N−1)-th connection controller 416-I(N−1). In so doing, the (N−1)-th DAC 414-I(N−1) determines the DAC value for minimizing the DC of the (N−1)-th RX VGA 418-I(N−1). Herein, the N-th connection controller 416-IN connects the (N−1)-th RX VGA 418-I(N−1) and the N-th RX VGA 418-IN.

As such, when the I channel RF processor 440 performs the RX DC calibration for the initial setting, the DC value input to the RX VGAs 418-I1 through 418-IN is sequentially blocked using the respective connection controllers 416-I1 through 416-IN.

The RX VGAs 418-I1 through 418-IN variably amplify the input signal according to the input signal level in order to apply the constant signal level to the baseband processor 430. For example, for the high input signal level, the RX VGAs 418-I1 through 418-IN amplify the signal with a small gain. By contrast, for the low input signal level, the RX VGAs 418-I1 through 418-IN amplify the signal with a great gain.

The buffer 420-I is disposed at an output stage of the I channel RF processor 440 and used to lower output impedance of the I channel RF processor 440.

The baseband processor 430 includes an I channel baseband processor 460 and a Q channel baseband processor 470. Hereafter, the I channel baseband processor 460 is explained alone because the I channel baseband processor 460 and the Q channel baseband processor 470 have the same structure merely with different signal channels processed.

The I channel baseband processor 460 includes an ADC 432-I, a switch 434-I, a modem 436-I, and a calibration module 438-I.

The ADC 432-I converts an analog signal output from the I channel RF processor 440 to a digital signal.

The switch 434-I controls connections of the ADC 432-I, the modem 436-I, and the calibration module 438-I according to the RX DC calibration. For example, for the RX DC calibration, the switch 434-I connects the ADC 432-I and the calibration module 438-I. For example, when the RX DC calibration is not performed, the switch 434-I connects the ADC 432 and the modem 436-I.

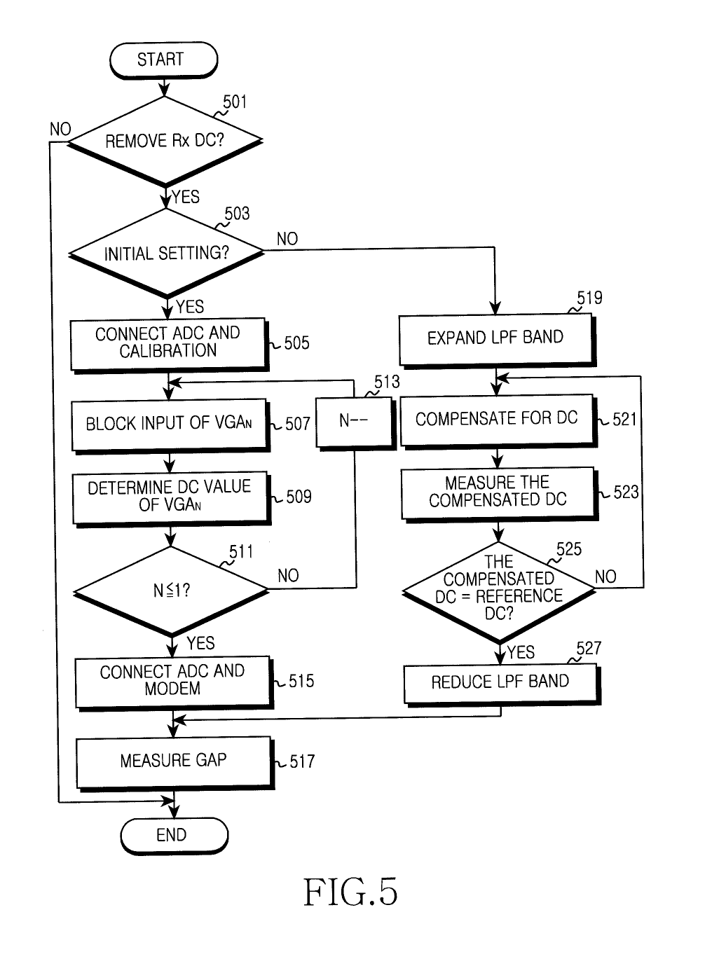

FIG. 5 is a flowchart of a method for reducing a signal distortion of RX DC in a wireless communication system according to an exemplary embodiment of the present disclosure.

Referring to FIG. 5, the terminal of the wireless communication system determines whether to remove the RX DC in step 501.

When determining not to remove the RX DC, the terminal finishes this process.

By contrast, when the terminal determines to remove the RX DC, the terminal determines whether the RX DC is removed for the initial setting in step 503.

When the RX DC is removed for the initial setting, the terminal sets to provide the output signal of the RF processor to the calibration module of the baseband processor for the RX DC calibration in step 505. For example, when the terminal is constructed as shown in FIG. 4, the terminal connects the ADC 432-I and the 432-Q and the calibration module 438-I and the 438-Q using the switch 434-I and the 434-Q of the baseband processor 430.

In step 507, the terminal blocks the input of the N-th VGA. For example, the terminal blocks the DC value input to the N-th VGA. Herein, N being the initial value includes the total number of the VGAs of the RF processor.

In step 509, the terminal determines the DAC value to minimize the DC of the N-th VGA by changing the DAC value of the N-th DAC.

In step 511, the terminal compares the VGA index N with 1 so as to determine whether the DAC value is determined for every VGA of the RF processor.

When the VGA index N is greater than 1, the terminal recognizes that the DAC values of all of the VGAs of the RF processor are not determined. Hence, the terminal updates the VGA index (N—) in step 513.

In step 507, the terminal blocks the input of the VGA having the index updated in step 513.

By contrast, when the index N of the VGA is 1 in step 511, the terminal recognizes that the DAC values of all of the VGAs of the RF processor are determined. Thus, the terminal sets to provide the output signal of the RF processor to the modem of the baseband processor for the RX parameter measurement in step 515. For example, when the terminal is constructed as shown in FIG. 4, the terminal connects the ADC 432-I and 432-Q and the modem 436-I and 436-Q using the switch 434-I and 434-Q of the baseband processor 430.

In step 517, the terminal measures the RX parameters of the corresponding band.

By contrast, when the RX DC is removed not for the initial setting in step 503, the terminal expands the pass band of the LPF 210 of the DC compensator to reduce the DC compensation time in step 519.

In step 521, the terminal compensates for the DC using the LPF 210 of the expanded pass band.

In step 523, the terminal measures the DC component of the DC signal compensated by the DC compensator.

In step 525, the terminal compares the DC component of the DC compensated signal with a reference DC to determine the end point of the RX DC calibration. Herein, the reference DC includes a particular DC value or a particular DC range.

When the DC component of the DC compensated signal is different from the reference DC, the terminal recognizes that the RX DC calibration needs to continue. Hence, the terminal compensates for the DC using the LPF 210 of the expanded pass band in step 521.

By contrast, when the DC component of the DC compensated signal is the same as the reference DC, the terminal reduces the pass band of the LPF 210 of the DC compensator in order to avoid the signal quality degradation in step 527.

In step 517, the terminal measures the RX parameters of the corresponding band and finishes this process.

As set forth above, a DC offset of an RFIC is controlled according to a service band change of a terminal in a wireless communication system using multiple bands. Thus, RX DC calibration delay can be reduced, and signal distortion of the RX DC can be reduced in the RX parameter measurement.

While the disclosure has been shown and described with reference to certain exemplary embodiments thereof, it will be understood by those skilled in the art that various changes in form and details may be made therein without departing from the spirit and scope of the disclosure as defined by the appended claims and their equivalents.

What is claimed is:

1. A receiver apparatus in a wireless communication system, the apparatus comprising:
a local oscillator;
a mixer for converting a received signal to a baseband signal using a frequency provided from the local oscillator; and
a DC compensator, including an operational amplifier and a low pass filter, for compensating DC in an output signal of a frequency converter by adjusting a pass band size of the low pass filter.

2. The apparatus of claim 1, wherein the DC compensator feeds an output of the operational amplifier back as an input using the low pass filter.

3. The apparatus of claim 1, wherein the DC compensator expands a pass band of the low pass filter when an RX DC calibration start point comes, and reduces the pass band of the low pass filter when an RX DC calibration time expires.

4. The apparatus of claim 1, further comprising:
a first Digital/Analog Converter (DAC) for providing a signal which minimizes a DC component of a first variable gain amplifier;
a first adder for adding a signal provided from the first DAC to a signal provided from the DC compensator;
a first connection controller for connecting the first adder and the first variable gain amplifier; and
the first variable gain amplifier for controlling a level of a signal provided from the first adder through the first connection controller.

5. The apparatus of claim 4, further comprising:
a second DAC for providing a signal which minimizes a DC component of a second variable gain amplifier;
a second adder for adding a signal provided from the second DAC to a signal provided from the first variable gain amplifier;
a second connection controller for connecting the second adder and the second variable gain amplifier; and
the second variable gain amplifier for controlling a level of a signal provided from the second adder through the second connection controller.

6. The apparatus of claim 1, further comprising:
a detector for detecting DC in an output signal of the DC compensator; and
a compensation controller for controlling a pass band of the low pass filter of the DC compensator by considering the DC detected by the detector.

7. The apparatus of claim 6, wherein the compensation controller controls to expand the pass band of the low pass filter when an RX DC calibration start point comes, and to reduce the pass band of the low pass filter when the DC detected by the detector falls within a reference DC range.

8. The apparatus of claim 7, wherein the reference DC range comprises a DC component size in the input signal detected after the RX DC calibration for initial setting.

9. The apparatus of claim 6, further comprising:
a first DAC for providing a signal which minimizes a DC component of a first variable gain amplifier;
a first adder for adding a signal provided from the first DAC to a signal provided from the detector;
a first connection controller for connecting the first adder and the first variable gain amplifier; and
the first variable gain amplifier for controlling a level of a signal provided from the first adder through the first connection controller.

10. A method for removing RX DC in a receiver of a wireless communication system, the method comprising:
down-converting a received signal to a baseband signal using a frequency converter; and
compensating for DC in the baseband signal by adjusting a pass band size of a low pass filter of a DC compensator.

11. The method of claim 10, wherein the DC compensator feeds an output of an operational amplifier back as an input using the low pass filter.

12. The method of claim 10, wherein the compensating of the DC comprises:
when an RX DC calibration start point comes, expanding a pass band of the low pass filter.

13. The method of claim 12, further comprising:
when an RX DC calibration time expires, reducing the pass band of the low pass filter.

14. The method of claim 12, further comprising:
detecting DC in the baseband signal of the compensated DC; and
determining a reduction point of a pass band of the low pass filter of the DC compensator by considering the detected DC.

15. The method of claim 14, wherein the determining of the reduction point comprises:
when the detected DC falls within a reference DC range, reducing the pass band of the low pass filter.

16. The method of claim 15, wherein the reference DC range comprises a DC component size in the input signal detected after the RX DC calibration for initial setting.
